(19) United States
(12) Patent Application Publication
(10) Pub. No.: US 2019/0197235 A1
(43) Pub. Date: Jun. 27, 2019

(54) SERVER AND SETTING METHOD THEREOF

(71) Applicant: INDUSTRIAL TECHNOLOGY RESEARCH INSTITUTE, Hsinchu (TW)

(72) Inventors: Tzi-Cker CHIUEH, Taipei City (TW); Li-Han CHEN, Taipei City (TW); Yu-Hsuan WANG, New Taipei City (TW); Chuan-Yu CHO, Hsinchu City (TW); Yi-Ting CHAO, Hsinchu City (TW)

(73) Assignee: INDUSTRIAL TECHNOLOGY RESEARCH INSTITUTE, Hsinchu (TW)

(21) Appl. No.: 16/150,172

(22) Filed: Oct. 2, 2018

(30) Foreign Application Priority Data
Nov. 24, 2017 (TW) 106140913

(51) Int. Cl. G06F 21/53; G06F 9/455

(52) U.S. Cl. CPC G06F 21/53; G06F 9/4401; G06F 9/45558

(57) ABSTRACT

A setting method for a server adapted for setting the server to run a virtual machine is provided. The setting method includes: obtaining a first memory address when a first service function of the virtual machine is called in a startup procedure of the virtual machine; correcting a memory block corresponding to the first memory address, to have an operation of the virtual being interrupted when the memory block is called by the virtual machine; determining, by a management module of the virtual machine, whether a script called by the first service function is executable or not, when the operation of the virtual machine is interrupted; if the script is not executable, interrupting, by the management module, the script called by the first service function;

and if the script is executable, allowing, by the management module, the first service function to execute the script.

### CROSS-REFERENCE TO RELATED APPLICATION

This application claims the priority benefits of Taiwan application serial no. 106140913, filed on Nov. 24, 2017. The entirety of each of the above-mentioned patent applications is hereby incorporated by reference herein and made a part of specification.

### TECHNICAL FIELD

The disclosure relates to a server and a setting method adapted for the server to run a virtual machine.

### BACKGROUND

A virtual machine is a Layer 2 operating system running on the underlying operating system of a computing device (for example., personal computer or server). One of the benefits is that users are free to switch between the underlying operating system and the Layer 2 operating system to handle a variety of tasks with different needs. Another benefit is that multiple users can share the same server without disturbing each other and the multiple users can use their own proprietary operating systems.

Since a virtual machine is a kind of operating system, various software are also used in the operation of the virtual machine. The virtual machine may automatically read a specific instruction set when opening a specific web page. Thus, the virtual machine itself is exposed to a risk of being attacked. In order to reduce the risk of being attacked, existing virtual machines usually have to configure a whitelist or a blacklist, or only allowing specific programs or instructions to be executed, or preventing specific programs or instructions from being executed. However, the management mechanism of the existing virtual machines for the whitelist or the blacklist is only for the general binary executable files, and the management mechanism fails to check the script directly. Script is a group of program commands to a computer system. The hackers, such as RansomWare or viruses may bypass the whitelist or the blacklist protection mechanism simply by using the script.

### SUMMARY

In one exemplary embodiment of the present disclosure provides a server and a setting method adapted to the server for checking the script executed in the virtual machine are provided.

In an exemplary embodiment of the present disclosure, a setting method for a server adapted for the server to run a virtual machine is provided. The setting method includes: obtaining a first memory address when a first service function of the virtual machine is called in a startup procedure of the virtual machine; correcting a memory block corresponding to the first memory address, to have an operation of the virtual machine being interrupted when the memory block is called by the virtual machine; determining, by a management module of the virtual machine, whether a script called by the first service function is executable or no; if the determining is the script is not executable, interrupting, by the management module, the script called by the first service function; and if the determining is the script is executable, allowing, by the management module, the first service function to execute the scrip.

In another exemplary embodiment of the present disclosure, a server adapted for running a virtual machine is provided, and the server includes a non-volatile storage medium, a memory, and a processor electrically coupled to the non-volatile storage medium and the memory. The non-volatile storage medium stores an instruction set used for running the virtual machine.

The instruction set is executed by the processor, to have the processor performing operations comprising: obtaining a first memory address when a first service function of the virtual machine is called in a startup procedure of the virtual machine; correcting a memory block corresponding to the first memory address of the memory, to have an operation of the virtual machine being interrupted when the memory block is called by the virtual machine; when the operation of the virtual machine is interrupted, determining, by a management module of the virtual machine, whether a script called by the first service function is executable or not; if the determining is the script is not executable, interrupting, by the management module, the script called by the first service; and if the determining is the script is executable, allowing, by the management module, the first service function to execute the script.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram illustrating a server according to an exemplary embodiment of the disclosure.

FIG. 2 is a schematic diagram illustrating a virtual machine running in a server according to an exemplary embodiment of the disclosure.

FIG. 3 is a flowchart illustrating a setting method for a server according to an exemplary embodiment of the disclosure.

FIG. 4 is a flowchart further illustrating the step S320 in FIG. 3 according to an exemplary embodiment of the disclosure.

FIG. 5A and FIG. 5B are schematic diagrams illustrating implementations of the steps S321 and S322 in FIG. 3, respectively, according to an exemplary embodiment of the disclosure.

FIG. 6A is a flowchart further illustrating the step S330 in FIG. 3 according to an exemplary embodiment of the disclosure.

FIG. 6B is a flowchart further illustrating the step S330 in FIG. 3 according to an exemplary embodiment of the disclosure.

### DETAILED DESCRIPTION

Descriptions of the disclosure are given with reference to the exemplary embodiments illustrated by the accompanying drawings. In addition, wherever possible, identical or similar reference numerals stand for identical or similar elements/components in the drawings and embodiments.

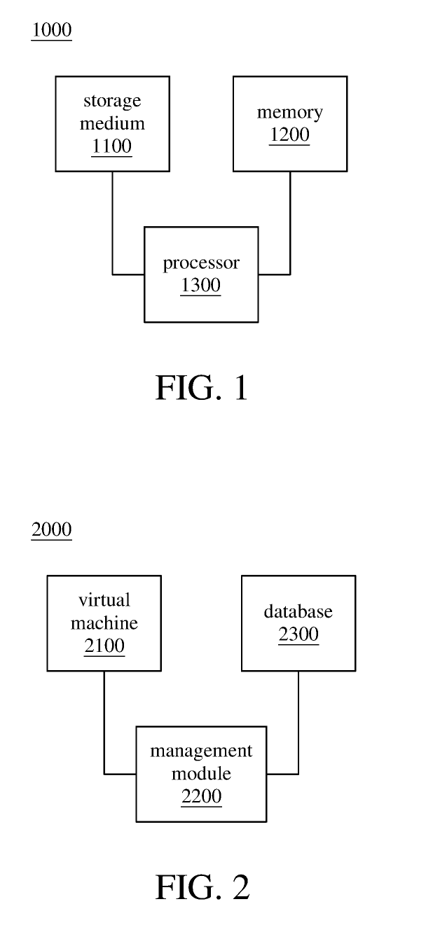

FIG. 1 is a block diagram illustrating a server according to an exemplary embodiment of the disclosure. FIG. 2 is a schematic diagram illustrating a virtual machine running in a server according to an exemplary embodiment of the disclosure. Referring to FIG. 1, in an exemplary embodiment of the disclosure, a server 1000 includes a physical non-volatile storage medium (for example, hard disk) 1100, a memory 1200, and a processor 1300. Referring to FIG. 1 and FIG. 2, in an exemplary embodiment of the disclosure, when the server 1000 reads the virtual machine instruction sets that are stored in the non-volatile storage medium 1100 and runs the virtual machine, there is a logical server system 2000 running in the server 1000. The server system 2000 includes a virtual machine 2100, a management module 2200, and a database 2300. Logically, the database 2300 is, for example, one or more pieces of data stored in the non-volatile storage medium 1100. The virtual machine 2100 and the management module 2200, for example, are stored in the memory 1200 (that is, occupied in specific blocks of the memory 1200), and to be read by the processor 1300 to run specific functions respectively. The virtual machine 2100 calls a service function of a non-kernel space program system call when executing the script. The service function of the non-kernel space program system call is referred to as a first service function hereinafter. The service function of the non-kernel space program system call, for example, is a “execve” system call in the UNIX operating system, and is a “CreateProcess” system call in the Microsoft Windows operating system. However, the skilled person in the art may create other functions that are analogous to the “execve” system call and/or the “CreateProcess” system call. The management module 2200 is, for example, a hypervisor in the UNIX operating system.

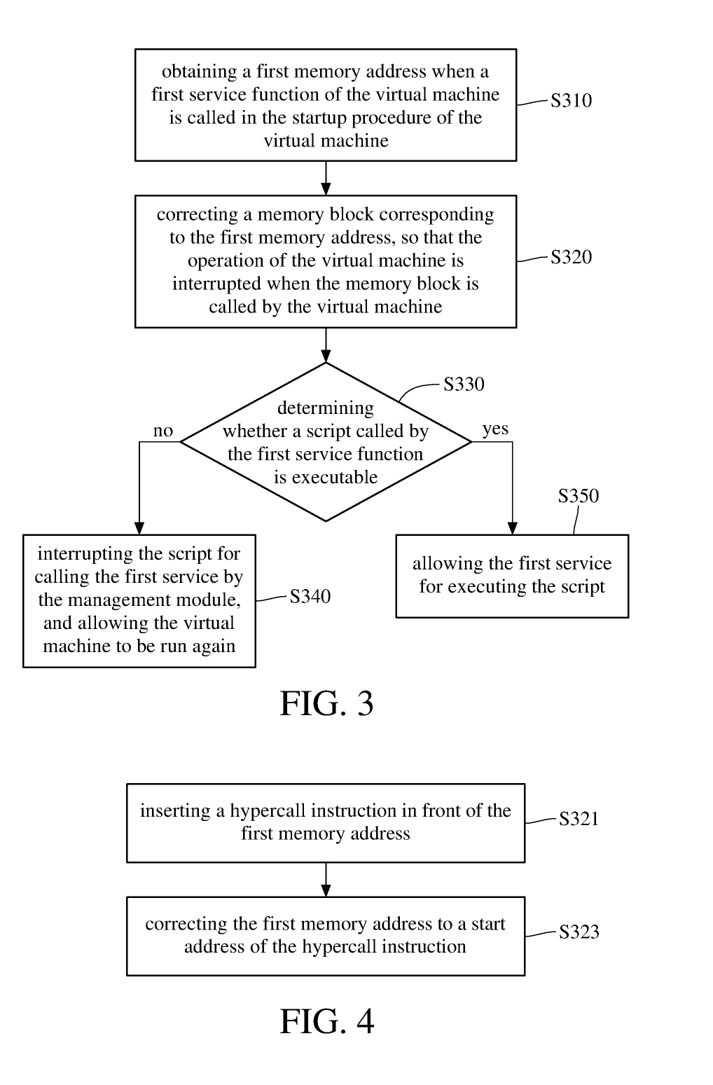

Next, a setting method for a server according to an embodiment of the present disclosure will be described. FIG. 3 is a flowchart illustrating a setting method for a server according to an exemplary embodiment of the disclosure. With reference to FIG. 3, in step S310, in the startup procedure of the virtual machine 2100, the processor 1300 runs the management module 2200 to obtain a first memory address when a first service function is called. In step S320, the processor 1300 corrects at least one memory block corresponding to the first memory address of the memory 1200 directly, or the management module 2200 corrects at least one memory block corresponding to the first memory address of the memory 1200. So that when the memory block is called by the virtual machine 2100, the operation of the virtual machine 2100 is interrupted. Therefore, when the virtual machine 2100 executes the script, the first service function is called and then the aforementioned memory block is called to have the operation of the virtual machine 2100 being interrupted. At the moment, as shown in step S330, the management module 2200 determines whether the script called by the first service function is executable or not.

If the script is not executable, as shown in step S340, the management module 2200 interrupts the script called by the first service function, and allows the virtual machine 2100 to operate again. If the script is executable, as shown in step S350, the management module 2200 allows the first service function to execute the script.

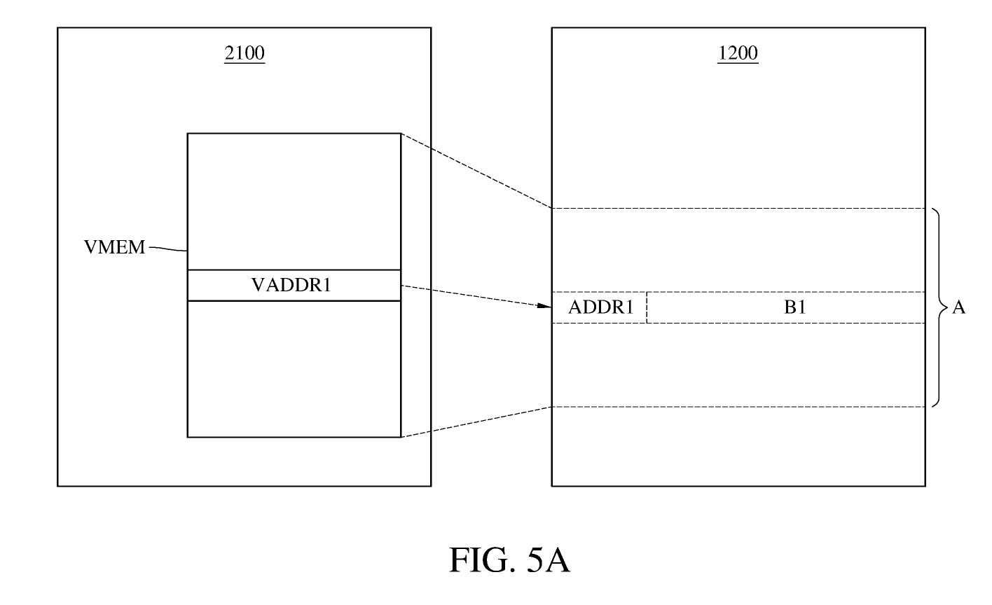

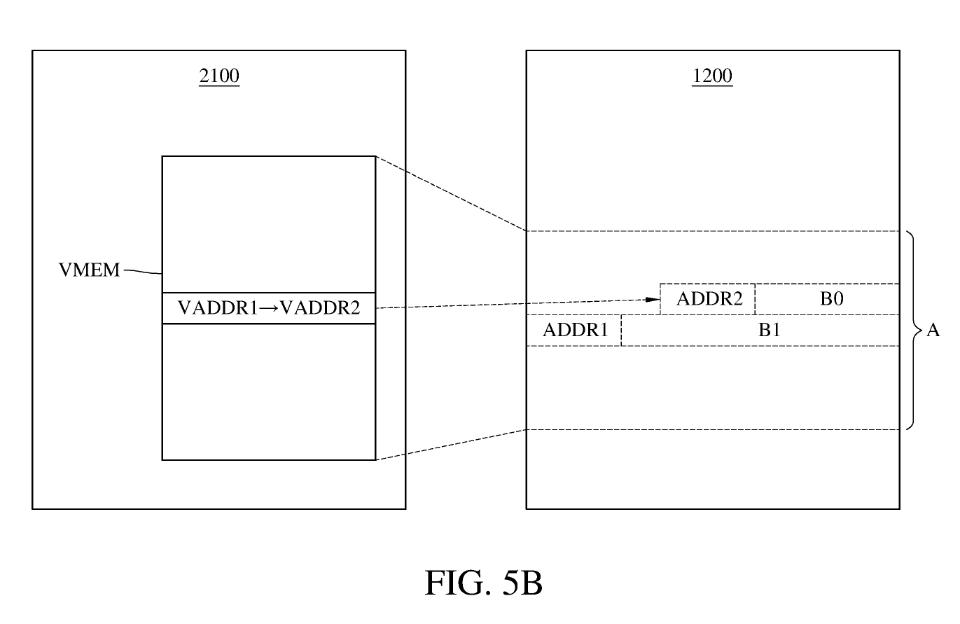

In one exemplary embodiment of the disclosure, the detailed of step S320 will be illustrated in FIG. 4. FIG. 4 is a flowchart further illustrating the step S320 according to an exemplary embodiment of the disclosure. With reference to FIG. 4, in step S321, the processor 1300 inserts a hypercall instruction before the first memory address in the memory 1200. In step S323, the processor 1300 corrects the first memory address to be a starting address of the hypercall instruction. To be specific, please refer to FIG. 5A and FIG. 5B, FIG. 5A and FIG. 5B are schematic diagrams illustrating implementations of the steps S321 and S322 in FIG. 3, respectively, according to an exemplary embodiment of the disclosure. With reference to FIG. 5A, a virtual memory VMEM of the virtual machine 2100 is mapped to a memory block A of the memory 1200 of the server 1000, when the virtual machine 2100 is running. To be specific, the virtual machine 2100 defines a function table which records a plurality of virtual memory addresses, wherein each virtual memory address in the virtual memory VMEM is the virtual memory address called by each function call. For example, the function table predefined a first virtual memory address VADDR1 in the virtual memory VMEM theat is called by the first service function. The first virtual memory address VADDR1 is mapped to the first memory address ADDR1 of the memory block A of the memory 1200. Therefore, in the memory block A of the memory 1200, the first service function is stored in the memory block B1 with the starting address of the first memory address ADDR1.

With reference to FIG. 5B, in the memory block A of the memory 1200 of the server 1000, the processor 1300 writes a hypercall instruction into a memory block B0 preceding the first memory address ADDR1. The starting address of the memory block B0 is a second memory address ADDR2. Therefore, the management module 2200 of the processor 1300 modifies the function table of the virtual machine 2100 and corrects the first virtual memory address VADDR1 to be a second virtual memory address VADDR2. Wherein the second virtual memory address VADDR2 is mapped to the second memory address ADDR2 in the memory block A of the memory 1200 of the server 1000.

In the way, when the virtual machine 2100 executes the script, the virtual machine 2100 actually executes the second memory address ADDR2 of the memory 1200, and the hypercall instruction is executed first, so that the operation of the virtual machine 2100 is interrupted, and the operation is controlled by the management module 2200. The management module 2200 then executes the aforementioned step S330 or even continues to execute to step S340 or step S350. Then, the management module 2200, based on the results of the aforementioned steps, allows or disallows the object which triggers or calls the hypercall instruction to be executed (that is, allow or disallow the scrip to be executed), and let the virtual machine 2100 continues running. Therefore, if a user of the virtual machine 2100 wants to execute the allowed script, the management module 2200 enables the virtual machine 2100 to execute the script. On the other hand, if a user of the virtual machine 2100 wants to execute the disallowed script, the management module 2200 disables the virtual machine 2100 to prevent the script from being executed.

In another exemplary embodiment of the disclosure, in step S320, the management module 2200 of the processor 130 does not insert the hypercall instruction before the first memory address ADDR1. The management module 2200 rewrites the program codes (that is, the first service function) in the memory block B1 and the hypercall instruction into the memory block B1 to overwrite the original content. Wherein the hypercall instruction is written to the starting address of the memory block B 1, namely, the first memory address ADDR1. In other words, when the virtual machine 2100 tries to execute the first service function by executing the first memory address ADDR1, the hypercall instruction is executed first, so that the operation of the virtual machine 2100 is interrupted and then the management module 2200 is called.

In yet other exemplary embodiment of the disclosure, the aforementioned step S320 may be amended to be non-executable by modifying the attribute of the memory block B 1. In one embodiment, when the processor 1300 runs the management module 2200 to execute step S320, the attribute of the first memory address ADDR1 is modified to be non-writable. When executing the script, the virtual machine 2100 attempts to execute the non-writable first memory address ADDR1 of the memory 1200, and therefore generates an exception event. In the case, the management module 2200 needs to execute an exception handle, so that the virtual machine 2100 temporarily stops running and waits for the management module 2200 to complete the exception handle (namely, step S330 and subsequent steps).

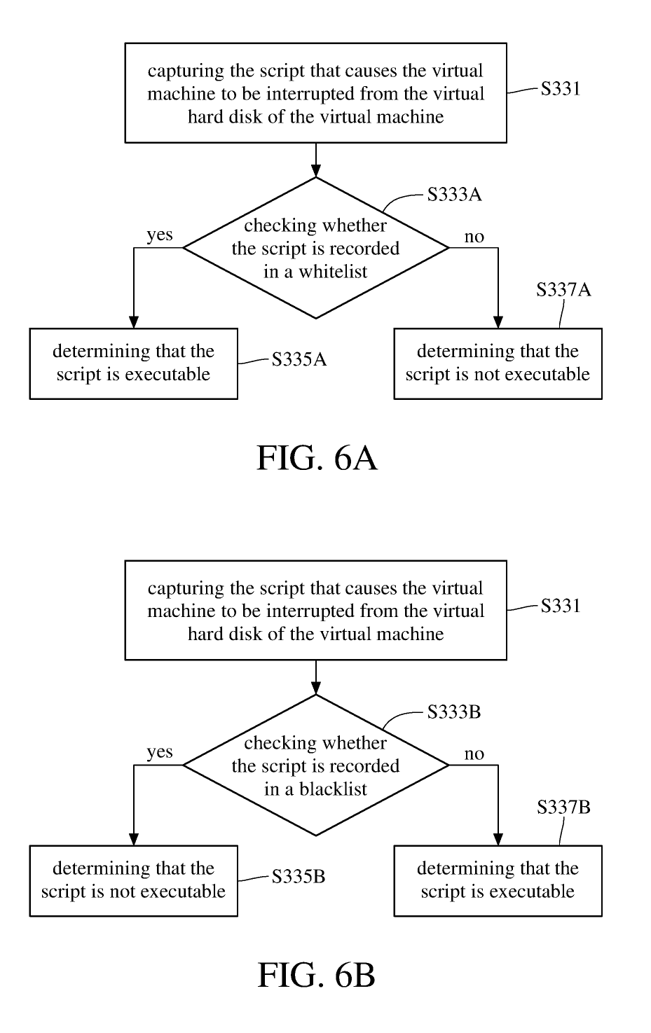

In one exemplary embodiment of the disclosure, an implementation of step S330 will be illustrated in FIG. 6A. FIG. 6A is a flowchart further illustrating the step S330 according to an exemplary embodiment of the disclosure. With reference to FIG. 6A, in step S331, the management module 2200 captures an object (namely, the script) from the virtual hard disk of the virtual machine 2100, wherein the object causes the virtual machine 2100 to be interrupted In step S333A, the management module 2200 checks whether the script is recorded in a whitelist of the database 2300 or not. If the script is recorded in the whitelist, the management module 2200 determines the script is executable, as shown in step S335A. If the script is not recorded in the whitelist, the management module 2200 determines the script is not executable, as shown in step S337A.

To be specific, in step S333A, the management module 2200 parses the script entirely to obtain a checksum. Wherein the entire content of the script have to be parsed to obtain the checksum. Then, the management module 2200 searches for the whitelist of the database 2300 to determine whether the checksum is recorded in the whitelist or not. Specifically, if the checksum of a script is recorded in the whitelist, the script is executable.

In yet another exemplary embodiment of the disclosure, the implementation of step S330 will be illustrated in FIG. 6B. FIG. 6B is a flowchart further illustrating the step S330 according to an exemplary embodiment of the disclosure. With reference to FIG. 6B, in step S331, the management module 2200 captures an object (namely, the script) from the virtual hard disk of the virtual machine 2100, wherein the object causes the virtual machine 2100 to be interrupted. In step S333B, the management module 2200 checks whether the script is recorded in a blacklist of the database 2300 or not. If the script is recorded in the blacklist, the management module 2200 determines the script is not executable, as shown in step S335B. If the script is not recorded in the blacklist, the management module 2200 determines the script is executable, as shown in step S337B.

To be specific, in step S333B, the management module 2200 parses the script entirely to obtain a plurality of feature blocks corresponding to the script. The management module 2200 parses each of the feature blocks to obtain a plurality of checksums corresponding to the aforementioned plurality of feature blocks. Then, the management module 2200 searches for the blacklist of the database 2300 to determine whether any of the checksums is recorded in the blacklist. Specifically, if any of the plurality of checksums corresponding to the plurality of feature blocks of a script is recorded in the blacklist, the script is not executable.

With the aforesaid embodiments, when a user of the virtual machine 2100 executes an instruction having a script, or the virtual machine 2100 receives other instruction resources (such as a web page or an email) that request to execute a specific command having a script, then once the script is executed, the virtual memory address defined in the function table (namely, the first virtual memory address VADDR1 or the second virtual memory address VADDR2) will be executed. Then, the operation of the virtual machine 2100 is interrupted, and the management module 2200 is called for an exception control. Therefore, the management module 2200 can parse if the script causing the interrupt event is defined in a whitelist or in a blacklist, and thus can determine whether the script is executable or not.

Since checking a whitelist or a blacklist is not executed by the virtual machine 2100 but executed by the management module 2200, therefore, when a new script is to be added to the whitelist or the blacklist, the maintainer of the server 1000 does not need to update each virtual machine. Instead, only the management module 2200 needs to be updated, so as to reduce the complexity of the maintenance.

In addition, according to the embodiments of the present disclosure, a server or a setting method adapted for the server, uses the management module to perform the modifications of the virtual memory VMEM, the specific addressor the specific block of the memory 1200, without occupying any hardware debugging resource. Specifically, no matter how many virtual machines are running in the server 1000, once the virtual machines execute the script, the virtual machines will trigger the aforementioned interrupt event, to have the management module involving the performing of exception control.

In summary, according to the embodiment of the present disclosure, the setting method adapted for the server modifies a specific memory block, to have a virtual memory interrupting the operation when the virtual memory tries to execute a script. Also, the script that causes the interrupt event is checked. Under the premise of no need to update instruction set of the virtual machine, intercepting and checking the script is achieved.

Although the invention has been disclosed by the above embodiments, they are not intended to limit the invention. It will be apparent to one of ordinary skill in the art that modifications and variations to the invention may be made without departing from the spirit and scope of the invention. Therefore, the scope of the invention will be defined by the appended claims.

What is claimed is:

1. A setting method adapted for a server to run a virtual machine, the setting method comprising:
obtaining a first memory address when a first service function of the virtual machine is called in a startup procedure of the virtual machine;
correcting a memory block corresponding to the first memory address, to have an operation of the virtual machine being interrupted when the memory block is called by the virtual machine;
determining, by a management module of the virtual machine, whether a script called by the first service function is executable or not, when the operation of the virtual machine is interrupted;
if the script is not executable, interrupting, by the management module, the script called by the first service function; and
if the script is executable, allowing, by the management module, the first service function to execute the script.

2. The setting method as claimed in claim 1, wherein the step of correcting the memory block corresponding to the first memory address comprises:
inserting a hypercall instruction before the first memory address; and
correcting the first memory address to be a starting address of the hypercall instruction.

3. The setting method as claimed in claim 1, wherein the step of correcting the memory block corresponding to the first memory address comprises:
amending an attribute of the memory block to be not executable.

4. The setting method as claimed in claim 1, wherein the step of determining, by the management module, whether the script called by the first service is executable or not comprises:
checking whether the script is recorded in a whitelist or not; and
if the script is recorded in the whitelist, determining the script is executable; and
if the script is not recorded in the whitelist, determining the script is not executable.

5. The setting method as claimed in claim 4, wherein the step of checking whether the script is recorded in the whitelist or not comprises:
parsing the script entirely to obtain a checksum; and
determining whether the checksum is recorded in the whitelist or not.

6. The setting method as claimed in claim 1, wherein the step of determining, by the management module, whether the script called by the first service is executable or not comprises:
checking whether the script is recorded in a blacklist or not;
if the script is recorded in the blacklist, determining the script is not executable; and
if the script is not recorded in the blacklist, determining the script is executable.

7. The setting method as claimed in claim 6, wherein the step of checking whether the script is recorded in the blacklist or not comprises:
parsing the script to obtain a plurality of feature blocks;
parsing each of the plurality of feature blocks to obtain a plurality of checksums; and
determining whether the plurality of checksums is recorded in the blacklist or not.

8. A server, adapted for running a virtual machine, comprising:
a non-volatile storage medium, storing an instruction set used for running the virtual machine;
a memory; and
a processor, electrically coupled to the non-volatile storage medium and the memory, wherein the instruction set is executed by the processor, to have the processor performing operations comprising:
obtaining a first memory address when a first service function of the virtual machine is called in a startup procedure of the virtual machine;
correcting a memory block corresponding to the first memory address of the memory, to have an operation of the virtual machine being interrupted when the memory block is called by the virtual machine;
when the operation of the virtual machine is interrupted, determining, by a management module of the virtual machine, whether a script called by the first service function is executable or not;
if the script is not executable, interrupting, by the management module, the scrip called by the first service function; and
if the script is executable, allowing, by the management module, the first service function to execute the script.

9. The server as claimed in claim 8, wherein the processor corrects the memory block corresponding to the first memory address in the memory comprises:
inserting a hypercall instruction before the first memory address; and
correcting the first memory address to be a starting address of the hypercall instruction.

10. The server as claimed in claim 8, wherein the processor corrects the memory block corresponding to the first memory address in the memory comprises.
amending an attribute of the memory block to be not executable.

11. The server as claimed in claim 8, wherein the processor executes the step of a management module of the virtual machine determines whether the script called by the first service is executable comprises:
check whether the script is recorded in a whitelist; and
if the script is recorded in the whitelist, determining the script is executable; and
if the script is not recorded in the whitelist, determining the script is not executable.

12. The server as claimed in claim 11, wherein the processor checks whether the script is recorded in a whitelist further comprises:
parsing the script entirely to obtain a checksum; and
determining whether the checksum is recorded in the whitelist or not.

13. The server as claimed in claim 8, wherein the processor executes the step of determining, by the management module of the virtual machine, whether the script called by the first service function is executable or not comprises:
checking whether the script is recorded in a blacklist or not;
if the script is recorded in the blacklist, determining the script is not executable; and
if the script is not recorded in the blacklist, determining the script is executable.

14. The server as claimed in claim 13, wherein the processor checks whether the script is recorded in a blacklist further comprises:
parsing the script to obtain a plurality of feature blocks;
parsing each of the plurality of feature blocks to obtain a plurality of checksums; and
determining whether the plurality of checksums is recorded in the blacklist or not.
